(19) United States
(12) Patent Application Publication
(10) Pub. No.: US 2019/0263970 A1
(43) Pub. Date: Aug. 29, 2019

(54) ORGANOPOLYSILOXANE COMPOSITION

(71) Applicant: KCC CORPORATION, Seoul (KR)

(72) Inventors: Jang Min LEE, Gyeonggi-do (KR); Il Hyuck YOO, Gyeonggi-do (KR); Kyung Nam KIM, Jeollabuk-do (KR); Tae Hwan PARK, Seoul (KR)

(73) Assignee: KCC CORPORATION, Seoul (KR)

(21) Appl. No.: 16/347,987

(22) PCT Filed: Nov. 10, 2017
(86) PCT No.: PCT/KR2017/012759

§ 371 Date: May 7, 2019

(30) Foreign Application Priority Data
Nov. 11, 2016 (JP) 10-2016-0150489

(51) Int. Cl. C08G 77/16; C08K 3/26; C08K 5/5419; C08L 83/04

(52) U.S. Cl. CPC C08G 77/16; C08K 3/26; C08L 2312/08; C08L 83/04; C08K 2003/265; C08K 5/5419

(57) ABSTRACT

Embodiments relate to an organopolysiloxane composition which includes: an organopolysiloxane polymer containing a silicon-bonded hydroxyl group or a silicon-bonded hydrolysable group; light calcium carbonate having a specific surface area according to the BET method of 15 to 35 m²/g; heavy calcium carbonate having a specific surface area according to the BET method of 0.5 to 5 m²/g; a curing accelerating catalyst; and a silane-based curing agent, wherein the mixing weight ratio of the light calcium carbonate and the heavy calcium carbonate is 1:0.04 to 1:0.25, and the silane-based curing agent is a compound represented by the following formula: Gₓ-Si—R₄₋ₓ, G is selected from the group consisting of alkoxy, acetoxy, oxime, and a hydroxy group, R is selected from the group consisting of a C₁ to C₁₀ alkenyl group, a C₁ to C₁₀ alkynyl group, and a C₆ to C₁₀ aryl group, and X is 2, 3, or 4.

### CROSS-REFERENCE TO RELATED APPLICATIONS

This application is based on and claims the benefit of priority to Korean Patent Application No. 10-2016-0150489, filed on Nov. 11, 2016, in the Korean Intellectual Property Office, the disclosure of which is incorporated herein in its entirety by reference.

### BACKGROUND

Embodiments relate to an organopolysiloxane composition, and more particularly, to an organopolysiloxane composition, which includes different types of calcium carbonate with different BET specific surface areas in a specific range.

### DESCRIPTION OF THE RELATED ART

Generally, an organosiloxane composition is cured to become a silicone rubber with excellent weather resistance or the like, and thus can be used as an adhesive or sealant in various fields including construction and civil engineering fields.

To prepare such an organosiloxane composition, various organosiloxane compositions including an organosilicone polymer as a main ingredient, and further including a filler, a curing accelerator, a curing agent and a coupling agent have been developed. For example, organosiloxane compositions including an organosilicon compound having at least two silicon-bound hydrolysable groups; calcium carbonate; a curing accelerator; a silane compound; and a silane coupling agent have been studied.

Specifically, a composition prepared by curing an organopolysiloxane polymer, light calcium carbonate powder and a trialkoxysilane in the presence of a condensation reaction-accelerating catalyst such as titanium ethylacetoacetate was suggested. However, although the composition may have excellent storage stability, adhesion durability may be low. Particularly, when a calcium carbonate filler with a small average particle size is used alone, a coating strength may be easily reduced, and after long-term curing, surface adhesion may be reduced.

To solve these problems, although compositions which include calcium carbonate surface-treated in various ways and additives have been studied, when such compositions are exposed or used for a long time, an adhesive layer may be destroyed, or when compositions are exposed to water or a humid condition, they have poor water resistance and probably have problems such as decreased adhesion.

Therefore, it is necessary to develop an organopolysiloxane composition which can have an excellent shear bond strength, can ensure an initial adhesive strength due to a fast surface curing speed, cannot be easily delaminated in long-term use, and can have excellent adhesion.

(Patent Literature 1) EP 1976933 B1

(Patent Literature 2) US 2007-0282047 A1

### SUMMARY

Embodiments provide an organopolysiloxane composition with improved shear bond strength and water resistance.

More particularly, embodiments provide an organopolysiloxane composition, which includes an organopolysiloxane polymer containing two or more silicon-bound hydroxyl groups or silicon-bound hydrolysable groups, light calcium carbonate having a BET specific surface area of 15 to 35 m²/g, heavy calcium carbonate having a BET specific surface area of 0.5 to 5 m²/g, a curing-accelerating catalyst and a silane-based curing agent, wherein a mixing weight ratio of the light calcium carbonate and the heavy calcium carbonate is 1:0.04 to 1:0.25, and the silane-based curing agent is a compound represented by Formula 4 below.

Gₓ-Si—R₄₋ₓ [Formula 4]

In Formula 4, G is selected from the group consisting of an alkoxy group, an acetoxy group, an oxime group and a hydroxyl group, R is selected from the group consisting of a C₁ to C₁₀ alkenyl group, a C₁ to C₁₀ alkynyl group and a C₆ to C₁₀ aryl group, and x is 2, 3 or 4.

Embodiments provide non-obvious advantages over the convention art. For example, an organopolysiloxane composition according to an embodiment can have excellent shear bond strength and elongation, and maintain excellent water resistance and adhesion durability even after curing or in long-term use.

### DETAILED DESCRIPTION

Hereinafter, the various embodiments will be described.

Embodiments relate to an organopolysiloxane composition, which includes (a) an organopolysiloxane polymer containing two or more silicon-bound hydroxyl groups or silicon-bound hydrolysable groups, (b) light calcium carbonate having a Brunauer-Emmett-Teller (BET) specific surface area of 15 to 35 m²/g, (c) heavy calcium carbonate having a BET specific surface area of 0.5 to 5 m²/g, (d) a curing-accelerating catalyst, and (e) a silane-based curing agent, wherein a mixing weight ratio of the light calcium carbonate (b) and the heavy calcium carbonate (c) is in the range of 1:0.04 to 1:0.25.

The organopolysiloxane composition according to an embodiment includes different types of light calcium carbonate and heavy calcium carbonate, which have different BET specific surface areas at amounts in the specific range, and compared with the conventional organopolysiloxane composition including only a calcium carbonate with a specific BET specific surface area, may have excellent elongation and shear bond strength, and maintain excellent water resistance and adhesion durability even after curing or in long-term use.

Each component included in the organopolysiloxane composition according to at least one embodiment will be described in detail as follows.

(a) Organopolysiloxane Polymer

In the organopolysiloxane composition according to an embodiment, the organopolysiloxane polymer may be a compound represented by Formula 1 below.

X-A-X¹ [Formula 1]

In Formula 1, X and X¹ are the same or different, and each independently selected from the group consisting of siloxane groups terminated by a hydroxyl group or a hydrolysable group.

A is a siloxane containing a polymer chain.

X or X¹ terminated by the hydroxyl group or hydrolysable group is selected from the group consisting of —Si(OH)₃, —(R^{a})Si(OH)₂, —(R^{a})₂SiOH, —R^{a}Si(OR^{b})₂, —Si(OR^{b})₃, —(R^{a})₂SiOR^{b} and —(R^{a})₂Si—R^{c}—Si(R^{d})ₚ(OR^{b})₃₋ₚ.

R^{a} is a monovalent hydrocarbyl group, and R^{b} and R^{d} are each independently selected from the group consisting of a C₁ to C₁₀ alkyl group and a C₁ to C₁₀ alkoxy group.

R^{c} is a bivalent hydrocarbon group into which one or more siloxane spacers having 6 or less silicon atoms may be interposed, and p is 0, 1 or 2.

Specifically, in Formula 1, R^{a} may be a methyl group, and R^{b} and R^{d} may have 6 or less carbon atoms.

In Formula 1, the siloxane A may include a siloxane unit of Formula 2 below.

—(R⁵ₛSiO_{(4-s/2})— [Formula 2]

In Formula 2, R⁵ is a substituted or unsubstituted C₁ to C₁₀ hydrocarbyl group, and s is 0, 1 or 2.

The hydrocarbyl group may be substituted with an halogen atom such as chlorine, fluorine, bromine or iodine; a halogen atom-containing group such as a chloromethyl group, a perfluorobutyl group, a trifluoroethyl group, or a nonafluorohexyl group; an oxygen atom; an oxygen atom-containing group such as a (meth)acryl group or a carboxyl group; a nitrogen atom; a nitrogen atom-containing group such as an amino-functional group, an amido-functional group, or a cyano-functional group; a sulfur atom; or a sulfur atom-containing group such as a mercapto group.

Specifically, R⁵ may be a chlorine or fluorine-substituted propyl group such as a methyl group, an ethyl group, a propyl group, a butyl group, a vinyl group, a cyclohexyl group, a phenyl group, a tolyl group, a 3,3,3-trifluoropropyl group, a chlorophenyl group, a beta-(perfluorobutyl)ethyl group or a chloro cyclohexyl group.

In Formula 1, A may include any suitable siloxane or siloxane/organic molecule chain providing a viscosity of a polymer to be prepared (25 to 20,000,000 cP or less (i.e., the maximum 200,000 or more units of Formula 2) in the absence of a diluent according to at least one embodiment). Specifically, A may have a polydiorganosiloxane chain represented by Formula 3 below.

—(R⁵₂SiO)ₜ— [Formula 3]

In Formula 3, R⁵ is the same as described above, and t is an integer of 200,000 or less.

The viscosity of the organopolysiloxane polymer according to an embodiment may be 1,000 to 100,000 cP, specifically, 4,500 to 50,000 cP, and more specifically, 4,500 to 5,500 cP at 25° C. The viscosity is measured at 25° C. using a Brookfield HBDV-PRO viscometer.

The organopolysiloxane polymer containing the unit of Formula 2 may be an organopolysiloxane polymer having a terminus, a silicon-bound hydroxyl group or terminus, or a silicon-bound organic radical, which can be hydrolyzed using moisture as defined above. The organopolysiloxane polymer may be a homo polymer or a copolymer. In addition, a mixture of different organopolysiloxane polymers having a terminal condensable group may also be included.

A content of the organopolysiloxane polymer may be 20 to 45 wt %, specifically, 25 to 40 wt %, with respect to the total weight of the organopolysiloxane composition.

(b) Light Calcium Carbonate

In the organopolysiloxane composition according to an embodiment, the light calcium carbonate is a filler and a material added to reinforce a physical property, and particularly, a component for providing mechanical strength.

The light calcium carbonate may have a BET specific surface area of 15 to 35 m²/g, specifically, 23 to 29 m²/g. The specific surface area may be measured by a BET 6-point method according to a nitrogen gas adsorption-flow method using a porosimetry analyzer (Bell Japan Inc, Belsorp-II mini)

In addition, an average particle size of the light calcium carbonate may be 0.02 to 0.1 μm, specifically, 0.05 to 0.1 μm. The average particle size of the light calcium carbonate may be measured using a laser diffraction method. The laser diffraction method can generally measure particle sizes ranging from submicrons to several mm, and may obtain highly reproducible and highly decomposable results. The average particle size of the light calcium carbonate may be defined as a particle size (D₅₀) on the 50% basis of a particle size distribution.

A content of the light calcium carbonate may be 40 to 70 wt %, specifically, 40 to 60 wt %, with respect to the total weight of the organopolysiloxane composition, in a range satisfying the mixing ratio of the light and heavy calcium carbonates. When the content of the light calcium carbonate is less than 40 wt %, a mechanical property may be deteriorated, and when the content of the light calcium carbonate is more than 70 wt %, dispersity of the light calcium carbonate may be decreased.

The light calcium carbonate may be precipitated calcium carbonate, and may be prepared by dehydrating a light calcium carbonate slurry obtained by reacting dense limestone with carbon dioxide and drying the light calcium carbonate slurry.

In addition, the surface of the light calcium carbonate may or may not be treated with a fatty acid. The surface-treated light calcium carbonate may be specifically precipitated calcium carbonate treated with a treatment agent selected from the group consisting of an organochlorosilane, an organopolysiloxane, a hexaalkyldisilazane, a fatty acid, and a fatty acid derivative. The precipitated calcium carbonate surface-treated with a fatty acid may increase the dispersity of the organopolysiloxane polymer (component (a)) and improve the viscosity of the composition.

(c) Heavy Calcium Carbonate

In the organopolysiloxane composition according to an embodiment, the heavy calcium carbonate is for increasing shear bond strength which is decreased when the light calcium carbonate is used alone, and a BET specific surface area may be 0.5 to 5 m²/g, specifically, 0.2 to 1.2 m²/g.

Due to the use of the heavy calcium carbonate after the addition thereof, the composition according to at least one embodiment may have improved elongation and shear bond strength.

The heavy calcium carbonate may be calcium carbonate having an average particle size, particularly, 4 to 5 μm, which is relatively larger than that of the light calcium carbonate.

A BET specific surface area and an average particle size of the heavy calcium carbonate may be measured using the same methods as those for measuring the light calcium carbonate.

A content of the heavy calcium carbonate may be 1 to 15 wt %, specifically, 2 to 12 wt %, with respect to the total weight of the organopolysiloxane composition, within the range satisfying the mixing ratio of the light calcium carbonate and the heavy calcium carbonate. When the content of the heavy calcium carbonate is less than 1 wt %, coating strength may be decreased and durability may be reduced, and when the content of the heavy calcium carbonate is more than 15 wt %, a mechanical property is deteriorated, and thus it may be difficult to apply the organopolysiloxane composition as an adhesive or a sealant.

The heavy calcium carbonate may be ground calcium carbonate, and may be prepared by grinding white limestone and sorting the obtained ground product.

In addition, the surface of the heavy calcium carbonate may or may not be treated with a fatty acid. The surface-treated heavy calcium carbonate may be a heavy calcium carbonate which is specifically treated with a treatment agent selected from the group consisting of an organochlorosilane, an organopolysiloxane, a hexaalkyldisilazane, a fatty acid, and a fatty acid derivative.

According to an embodiment, a mixing weight ratio of the light calcium carbonate (b) and the heavy calcium carbonate (c) may be 1:0.04 to 1:0.25, specifically, 1:0.04 to 1:0.15. When the organopolysiloxane polymer is used with the light calcium carbonate and the heavy calcium carbonate, which are mixed in the above-mentioned mixing range, the organopolysiloxane composition according to at least one embodiment may be used as various adhesives or sealants, and achieve excellent mechanical properties such as excellent shear bond strength, elongation and tensile strength.

(d) Curing-Accelerating Catalyst

In the organopolysiloxane composition according to an embodiment, the curing-accelerating catalyst is a catalyst for accelerating curing and may be a condensation catalyst containing a metal. Specifically, as a curing-accelerating catalyst, a condensation catalyst containing a metal such as titanium, tin, lead, antimony, iron, cadmium, barium, manganese, zinc, chromium, cobalt, nickel, aluminum, gallium, germanium and zirconium may be used. A specific example of the curing-accelerating catalyst may be bis(ethyl acetoacetato-O1′-O3)bis(2-methylpropane-1-olato)titanium, tetraisopropoxytitane, tetra-t-butoxy titanium, or diisopropoxytitanium bis(ethylacetoacetate).

A content of the curing-accelerating catalyst may be 0.1 to 3 wt %, specifically, 0.5 to 2.5 wt %, with respect to the total weight of the organopolysiloxane composition. When the content of the curing-accelerating catalyst is less than 0.1 wt %, curing reactivity of the composition may be reduced, and when the content of the curing accelerating catalyst is more than 3 wt %, workability may be reduced due to excessive curing.

(e) Silane-Based Curing Agent

In the organopolysiloxane composition according to an embodiment, the silane-based curing agent may be a compound represented by Formula 4 below.

Gₓ-Si—R₄₋ₓ [Formula 4]

In Formula 4, G is selected from the group consisting of an alkoxy group, an acetoxy group, an oxime group and a hydroxyl group.

R is selected from the group consisting of a C₁ to C₁₀ alkenyl group, a C₁ to C₁₀ alkynyl group and a C₆ to C₁₀ aryl group, and x is 2, 3 or 4.

Specifically, G may be methoxy, ethoxy, propoxy, isopropoxy, butoxy, or t-butoxy, and R may be phenyl, vinyl, prophenyl, isoprophenyl, or hexenyl.

Specific examples of the silane-based curing agents may include vinyltrimethoxysilane, vinyltriethoxysilane, vinylethoxydimethoxysilane, vinylmethoxydiethoxysilane, vinylmethoxydioximosilane, vinylethoxydioximosilane, vinylmethoxydiacetoxysilane, vinylethoxydiacetoxysilane, vinylmethoxydihydroxysilane, vinylethoxydihydroxysilane, phenyltrimethoxysilane, vinyltriacetoxysilane, dibutoxy diacetoxysilane, phenyltripropionoxysilane, vinyltris(methylethylketoximo)silane, vinyltris(isoprophenoxy)silane, ethylpolysilicate, n-propylorthosilicate, and ethylorthosilicate, methylorthosilicate.

A content of the curing agent may be 1 to 10 wt %, specifically, 0.5 to 5 wt %, with respect to the total weight of the organopolysiloxane composition. When the content of the curing agent is less than 1 wt %, the composition may be gelated due to a reduced curing reaction, and when the content of the curing agent is more than 10 wt %, workability may be reduced due to excessive curing. Meanwhile, the organopolysiloxane composition according to an embodiment may further include a silane-containing compound (f), a glycol-based compound (g) and a silicone-based additive (h), which will be described in detail as below.

(f) Silane-Containing Compound

In the organopolysiloxane composition according to an embodiment, the silane-containing compound is an additive used to improve an adhesive property. Considering the adhesion and water resistance of the composition, the silane-containing compound may be a mixed compound of an epoxyalkylalkoxysilane compound, an amino-substituted alkoxysilane compound and an alkylalkoxysilane compound.

A specific example of the epoxyalkylalkoxysilane compound may be trimethoxy[3-(oxirane-2-yl methoxy)propyl]silane, (3-glycidyloxypropyl)trimethoxysilane, or a mixture thereof. A specific example of the amino-substituted alkoxysilane compound may be γ-aminopropyltriethoxysilane, 3-aminopropyltrimethoxysilane, 3-aminopropyltriethoxysilane, or a mixture thereof. A specific example of the alkylalkoxysilane compound may be trimethoxy(methyl)silane, 4-mercaptobutyltrimethoxysilane, 3-mercapto-3-methylpropyltrimethoxysilane, or a mixture thereof.

A mixing ratio of the epoxyalkylalkoxysilane compound, the amino-substituted alkoxysilane compound and the alkylalkoxysilane compound may be a weight ratio of 1:0.05 to 0.4:0.1 to 0.5. If the mixing ratio of the amino-substituted alkoxysilane compound and the alkylalkoxysilane compound exceeds the above-mentioned numerical range, adhesion and water resistance may be reduced.

Specifically, considering the adhesion and water resistance of the composition, as the silane-containing compound, a mixture of trimethoxy[3-(oxirane-2-yl methoxy)propyl]silane or (3-glycidyloxypropyl)trimethoxysilane, 3-aminopropyltriethoxysilane and trimethoxy(methyl)silane may be used.

A content of the silane-containing compound may be 0.03 to 15 wt %, specifically, 0.01 to 5 wt %, with respect to the total weight of the organopolysiloxane composition.

(g) Glycol-Based Compound

In the organopolysiloxane composition according to an embodiment, the glycol-based compound is an additive used to increase the storage stability of the composition.

A specific example of the glycol-based compound may be ethylene glycol, propylene glycol, 1,3-propanediol, 2-methyl-1,3-propanediol, 1,2-butanediol, 1,3-butanediol, 1,4-butanediol, 1,5-pentanediol, 1,6-hexanediol, 3-methyl-1,5-pentanediol, neopentyl glycol, diethylene glycol, dipropylene glycol, polyethylene glycol, polypropylene glycol, polytetramethylene glycol, or a mixture thereof.

A content of the glycol-based compound may be 0.001 to 5 wt %, with respect to the total weight of the organopolysiloxane composition. When the content of the glycol-based compound is less than 0.001 wt %, the storage stability effect of the composition may be insignificant, and when the content of the glycol-based compound is more than 5 wt %, a physical property of the composition may be deteriorated due to an excessive amount of the compound.

(h) Silicone-Based Additive

In the organopolysiloxane composition according to an embodiment, the silicone-based additive is an additive used to control a viscosity of the composition. The silicone-based additive may be an organopolysiloxane which does not react with an organopolysiloxane polymer, and has a viscosity of 90 to about 110 cSt at 25° C. A specific example of the silicone-based additive may be polydimethylsiloxane.

A content of the silicone-based additive may be 1 to 10 wt %, specifically, 1 to 3 wt %, with respect to the total weight of the organopolysiloxane composition. When the content of the silicone-based additive exceeds the above-mentioned range, an effect of controlling the viscosity of the composition may be decreased, or other physical properties may be affected.

Meanwhile, hydrotreated middle distillates (petroleum), instead of the silicone-based additive, may be used to control the viscosity of the composition.

According to an embodiment, the organopolysiloxane composition may further include other additives such as a pigment, an extender, a photoinitiator, an adhesion promoter, a heat stabilizer, a flame retardant, a UV stabilizer, a chain extender, a filler, a water remover, etc. as needed within a range of not inhibiting the physical properties of various embodiments.

The organopolysiloxane composition according to an embodiment may have a specific gravity of 1.42 to 1.52 when measured according to ASTM D792, a viscosity of 180 to 400 Pa·s when measured according to ASTM D4287, and a set-to-touch time of 30 minutes or less. In addition, adhesion may be 100% CF when measured according to ASTM C1193, tensile strength may be 2.0 MPa or more (specifically, 2.3 to 2.5 MPa) when measured according to ASTM D412, elongation may be 100% or more (specifically, 200 to 250%) when measured according to ASTM D412, and shear bond strength may be 2.0 MPa or more (specifically, 2.5 to 3.0 MPa) when measured according to ASTM D1002.

The organopolysiloxane composition according to an embodiment described above may be used as various adhesives, encapsulating agents, and sealants, specifically, a sealant, an adhesive or an encapsulating agent for assembling an electronic device, parts of an automobile, or construction.

Hereinafter, embodiments will be described in detail with reference to examples as follows. However, the following examples are merely provided to explain the various embodiments, and the various embodiments are not limited to the following examples.

### Example 1

As an organopolysiloxane polymer, dimethylhydroxy silyl-terminated polydimethylsiloxane (Siloxanes and Silicones, di-Me, hydroxy-terminated, SF2001EDK005) having a viscosity at 25° C. of 5,000 cP was added to a reactor at 37.372 wt %, with respect to the total weight of the organopolysiloxane composition, and stirred at RPM 70/300 under an atmospheric pressure of 1,013 mbar. Afterward, with respect to the total weight of the organopolysiloxane composition, 52.925 wt % of light calcium carbonate (SHIRAISHI KOGYO KAISHA, LTD., HAKUENCA CC) having a BET specific surface area of about 23 to 29 m²/g and an average particle size of about 0.08 μm and 2.5 wt % of heavy calcium carbonate (Omya Korea, Omyacarb 5T) having a BET specific surface area of about 0.97 m²/g and an average particle size of about 4.5 μm were added (the mixing weight ratio of the light and heavy mixed calcium carbonates=1:0.047), and subjected to maintenance of atmospheric pressure stirring for about 30 minutes, followed by application with a spatula. Subsequently, the mixture was subjected to vacuum stirring at RPM 70/300 under a pressure of 0 to 50 mbar for 40 minutes. Then, 0.156 wt % of propylene glycol and 2.179 wt % of polydimethylsiloxane (Siloxanes and Silicones, di-Me, hydroxy-terminated, SF1000NFX100) having a viscosity of 100 cSt at 25° C. as a silicone-based liquid additive were added to the mixture, and then stirred at RPM 50/70 under an atmospheric pressure of 1,013 mbar for about 1 minute. The mixture was vacuum-stirred at RPM 60/150 under a pressure of 0 to 50 mbar for about 10 minutes, and then a finely-dispersed compound was primarily subjected to application with a spatula. Afterward, 1.500 wt % of bis(ethyl acetoacetato-01′-03)bis(2-methylpropane-1-olato)titanium as a curing-accelerating catalyst, and 2.800 wt % of vinyltrimethoxysilane as a silane-based curing agent were added. The mixture was stirred again at RPM 50/70 under an atmospheric pressure of 1,013 mbar for about 1 minute, and vacuum-stirred at RPM 60/150 under a pressure of 0 to 50 mbar for about 10 minutes. Here, as adhesion promoters, silane-containing compounds such as 3-glycidyloxypropyl)trimethoxysilane, 3-aminopropyltriethoxysilane and trimethoxy(methyl)silane were added at 0.426 wt %, 0.050 wt % and 0.074 wt % at a molar ratio of 1:0.148:0.355, respectively, and then stirred at RPM 50/70 under an atmospheric pressure of 1,013 mbar for about 1 minute. The mixture was vacuum-stirred at RPM 60/150 under a pressure of 0 to 50 mbar for about 10 minutes. Here, a small portion of the silicone-based additive, that is, the polydimethylsiloxane, may be added every time when each additive was added.

Components and contents of the components in Example 1 are shown in Table 1 below.

### Example 2 to 8

Organopolysiloxane compositions were prepared in the same manner as described in Example 1, except that the compositions and contents shown in Table 1 below were applied.

TABLE 1

| | | Content (wt %) | | | | | | | |
|---|---|---|---|---|---|---|---|---|---|
| Component | | Example 1 | Example 2 | Example 3 | Example 4 | Example 5 | Example 6 | Example 7 | Example 8 |
| Dimethylhydroxy silyl-terminated | | 37.372 | 37.372 | 37.372 | 37.372 | 37.372 | 37.372 | 37.372 | 37.372 |
| polydimethylsiloxane having | | | | | | | | | |
| viscosity of 5,000 cP at 25° C. | | | | | | | | | |
| Polydimethylsiloxane having | | 2.197 | 2.197 | 2.197 | 2.197 | 2.197 | 2.197 | 2.197 | 2.197 |
| viscosity of 100 cSt at 25° C. | | | | | | | | | |
| Heavy calcium carbonate | | 2.500 | 5.600 | 8.500 | 11.080 | 2.500 | 2.500 | 2.500 | 2.500 |
| (BET: 0.97 m²/g) | | | | | | | | | |
| Light calcium carbonate | | 52.925 | 49.825 | 46.925 | 44.345 | 52.925 | 52.925 | 52.925 | 52.925 |
| (BET: 23~29 m²/g) | | | | | | | | | |
| Propylene glycol | | 0.156 | 0.156 | 0.156 | 0.156 | 0.156 | 0.156 | 0.156 | 0.156 |
| Bis(ethyl acetoacetato-O1′-O3)bis(2- | | 1.500 | 1.500 | 1.500 | 1.500 | 1.500 | 1.500 | 1.500 | 1.500 |
| methylpropane-1-olato)titanium | | | | | | | | | |
| Vinyltrimethoxysilane | | 2.800 | 2.800 | 2.800 | 2.800 | 2.800 | 2.800 | 2.800 | 2.800 |
| Silane- | (3-glycidyloxypropyl)- | 0.426 | 0.426 | 0.426 | 0.426 | 0.500 | 0.409 | 0.375 | 0.383 |
| containing | trimethoxysilane | | | | | | | | |
| compound | 3- | 0.050 | 0.050 | 0.050 | 0.050 | 0.025 | 0.116 | 0.093 | 0.100 |
| | aminopropyltriethoxysilane | | | | | | | | |
| | Trimethoxy(methyl)silane | 0.074 | 0.074 | 0.074 | 0.074 | 0.025 | 0.025 | 0.082 | 0.067 |

| | | | | | | | | |
|---|---|---|---|---|---|---|---|---|
| Total | 100.00 | 100.00 | 100.00 | 100.00 | 100.00 | 100.00 | 100.00 | 100.00 |

### Comparative Examples 1 to 11

Organopolysiloxane compositions were prepared in the same manner as described in Example 1, except that the compositions and contents shown in Table 2 below were applied.

TABLE 2

| | | Content (wt %) | | | | | | | | | | |
|---|---|---|---|---|---|---|---|---|---|---|---|---|
| | | Com- | Com- | Com- | Com- | Com- | Com- | Com- | Com- | Com- | Com- | Com- |
| | | parative | parative | parative | parative | parative | parative | parative | parative | parative | parative | parative |
| | | Exam- | Exam- | Exam- | Exam- | Exam- | Exam- | Exam- | Exam- | Exam- | Exam- | Exam- |
| Component | | ple 1 | ple 2 | ple 3 | ple 4 | ple 5 | ple 6 | ple 7 | ple 8 | ple 9 | ple 10 | ple 11 |
| Dimethylhydroxy silyl- | | 45.163 | 39.503 | 44.89 | 37.372 | 38.243 | 38.998 | 38.959 | 37.372 | 37.372 | 37.372 | 37.372 |
| terminated | | | | | | | | | | | | |
| polydimethylsiloxane | | | | | | | | | | | | |
| having viscosity of | | | | | | | | | | | | |
| 5,000 cP at 25° C. | | | | | | | | | | | | |
| Polydimethylsiloxane | | 1.736 | 1.597 | 1.815 | 2.197 | 1.736 | 1.597 | 1.596 | 2.197 | 2.197 | 2.197 | 2.197 |
| having viscosity of 100 cSt | | | | | | | | | | | | |
| at 25° C. | | | | | | | | | | | | |
| Heavy calcium | | — | — | 48.778 | 15.050 | 2.500 | 2.500 | 2.500 | 2.500 | 2.500 | 2.500 | 2.500 |
| carbonate | | | | | | | | | | | | |
| (BET: 0.97 m²/g) | | | | | | | | | | | | |
| Light calcium carbonate | | 48.78 | 54.925 | — | 40.375 | 52.925 | 52.925 | 52.925 | 52.925 | 52.925 | 52.925 | 52.925 |
| (BET: 23~29 m²/g) | | | | | | | | | | | | |
| Propylene glycol | | 0.17 | 0.156 | 0.177 | 0.156 | 0.170 | 0.156 | 0.156 | 0.156 | 0.156 | 0.156 | 0.156 |
| Bis(ethyl acetoacetato- | | 1.15 | 1.058 | 1.203 | 1.500 | 1.150 | 1.058 | 1.058 | 1.500 | 1.500 | 1.500 | 1.500 |
| O1′-O3)bis(2- | | | | | | | | | | | | |
| methylpropane-1- | | | | | | | | | | | | |
| olato)titanium | | | | | | | | | | | | |
| Vinyltrimethoxysilane | | 2.876 | 2.646 | 3.006 | 2.800 | 2.876 | 2.646 | 2.656 | 2.800 | 2.800 | 2.800 | 2.800 |
| Silane- | (3-glycidyloxypropyl)- | — | — | — | 0.426 | 0.400 | — | — | 0.188 | 0.350 | 0.516 | 0.410 |
| containing | trimethoxysilane | | | | | | | | | | | |
| compound | 3- | — | — | — | 0.074 | — | 0.070 | — | 0.28 | 0.186 | 0.015 | 0.01 |
| | aminopropyltriethoxysilane | | | | | | | | | | | |
| | Trimethoxy(methyl)silane | — | — | — | 0.050 | — | 0.050 | — | 0.082 | 0.014 | 0.019 | 0.130 |
| | N-(3-(trimethoxysilyl)propyl)- | 0.125 | 0.115 | 0.131 | — | — | — | 0.150 | — | — | — | — |
| | ethylenediamine | | | | | | | | | | | |

| | | | | | | | | | | | |
|---|---|---|---|---|---|---|---|---|---|---|---|
| Total | 100.00 | 100.00 | 100.00 | 100.00 | 100.00 | 100.00 | 100.00 | 100.00 | 100.00 | 100.00 | 100.00 |

### Experimental Example 1: Measurement of Physical Properties of Composition

Physical properties of the organopolysiloxane compositions of the examples and the comparative examples were evaluated by the following methods, and the results are shown in Tables 3 and 4 below.

1. Appearance: 20 to 30 g of each of the organopolysiloxane compositions of the examples and the comparative examples was discharged to a cardboard or opacity chart, and uniformly applied with a spatula to visually evaluate the appearance of the composition.

2. Color: In the appearance evaluation, the color of the composition applied to a cardboard or opacity chart was visually evaluated.

3. Specific gravity: Specific gravity was evaluated according to ASTM D 792.

4. Slump: Slump was evaluated according to ASTM D 2202.

5. Set-to-touch: Each of the organopolysiloxane compositions of the examples and the comparative examples was applied to a 2-mm sheet and exposed to air with a relative humidity, and then a set-to-touch time was measured.

6. Adhesion: Adhesion was evaluated according to ASTM C 1193.

7. Hardness: Hardness was evaluated according to ASTM D 2240.

8. Tensile strength: Tensile strength was evaluated according to ASTM D 412.

9. Elongation: Elongation was evaluated according to ASTM D 412.

10. Shear bond strength: Shear bond strength was evaluated according to ASTM D 1002.

11. Adhesion strength variation after water-resistant aging: Adhesion strength variation after water-resistant aging was evaluated according to ASTM D 1002.

TABLE 3

| Category | Example 1 | Example 2 | Example 3 | Example 4 | Example 5 | Example 6 | Example 7 | Example 8 |
|---|---|---|---|---|---|---|---|---|
| Appearance | Good | Good | Good | Good | Good | Good | Good | Good |
| Color | Good | Good | Good | Good | Good | Good | Good | Good |
| Specific | 1.48 | 1.48 | 1.49 | 1.49 | 1.48 | 1.48 | 1.48 | 1.48 |
| gravity | | | | | | | | |
| Viscosity (cP) | 220,000 | 200,000 | 184,000 | 175,000 | 230,000 | 225,000 | 220,000 | 220,000 |
| Slump | NONE | NONE | NONE | NONE | NONE | NONE | NONE | NONE |
| Set-to-touch | 8 | 8 | 10 | 8 | 10 | 8 | 10 | 8 |
| (min) | | | | | | | | |
| Adhesion | 100% CF | 100% CF | 100% CF | 100% CF | 100% CF | 100% CF | 100% CF | 100% CF |
| Hardness | 53 | 52 | 50 | 50 | 55 | 53 | 55 | 50 |
| Tensile | 2.5 | 2.2 | 1.8 | 1.8 | 2.4 | 2.3 | 2.4 | 2.5 |
| strength | | | | | | | | |
| (MPa) | | | | | | | | |
| Elongation (%) | 250 | 240 | 230 | 240 | 250 | 240 | 250 | 240 |
| Shear bond | 2.5 | 2.5 | 2.3 | 2.3 | 2.1 | 2.3 | 1.8 | 2.6 |
| strength (MPa) | | | | | | | | |
| Adhesion | −12 | −15 | −15 | −12 | −20 | −18 | −15 | −10 |
| strength | | | | | | | | |
| variation after | | | | | | | | |
| water-resistant | | | | | | | | |
| aging (%) | | | | | | | | |

TABLE 4

| | Comparative | Comparative | Comparative | Comparative | Comparative | Comparative |
|---|---|---|---|---|---|---|
| Category | Example 1 | Example 2 | Example 3 | Example 4 | Example 5 | Example 6 |
| Appearance | Good | Good | Good | Good | Good | Good |
| Color | Good | Good | Good | Good | Good | Good |
| Specific | 1.42 | 1.48 | 1.43 | 1.48 | 1.48 | 1.48 |
| gravity | | | | | | |
| Viscosity | 153,000 | 315,000 | 231,000 | 220,000 | 210,000 | 210,000 |
| (cP) | | | | | | |
| Slump | NONE | NONE | NONE | NONE | NONE | NONE |
| Set-to- | 12 | 7 | 14 | 8 | 10 | 10 |
| touch | | | | | | |
| (min) | | | | | | |
| Adhesion | 100% CF | 100% CF | 100% CF | 100% CF | 100% CF | 100% CF |
| Hardness | 52 | 60 | 50 | 53 | 52 | 55 |
| Tensile | 2.9 | 3 | 2.2 | 1.9 | 2.2 | 2.2 |
| strength | | | | | | |
| (MPa) | | | | | | |
| Elongation | 390 | 260 | 290 | 240 | 250 | 250 |
| (%) | | | | | | |
| Shear | 1.7 | 1.8 | 1.4 | 1.8 | 1.6 | 1.5 |
| bond | | | | | | |
| strength | | | | | | |
| (MPa) | | | | | | |
| Adhesion | −75 | −79 | −81 | −15 | −27 | −64 |
| strength | | | | | | |
| variation | | | | | | |
| after | | | | | | |
| water- | | | | | | |
| resistant | | | | | | |
| aging | | | | | | |
| (%) | | | | | | |
| | | Comparative | Comparative | Comparative | Comparative | Comparative |
| | Category | Example 7 | Example 8 | Example 9 | Example 10 | Example 11 |
| | Appearance | Good | Good | Good | Good | Good |
| | Color | Good | Good | Good | Good | Good |
| | Specific | 1.48 | 1.48 | 1.48 | 1.48 | 1.48 |
| | gravity | | | | | |
| | Viscosity | 220,000 | 220,000 | 200,000 | 210,000 | 180,000 |
| | (cP) | | | | | |
| | Slump | NONE | NONE | NONE | NONE | NONE |
| | Set-to- | 10 | 10 | 8 | 8 | 10 |
| | touch | | | | | |
| | (min) | | | | | |
| | Adhesion | 100% CF | 100% CF | 100% CF | 100% CF | 100% CF |
| | Hardness | 52 | 53 | 50 | 55 | 53 |
| | Tensile | 2.2 | 2.0 | 2.3 | 2.4 | 2.5 |
| | strength | | | | | |
| | (MPa) | | | | | |
| | Elongation | 250 | 250 | 250 | 240 | 250 |
| | (%) | | | | | |
| | Shear | 1.8 | 2.5 | 2.6 | 1.4 | 1.5 |
| | bond | | | | | |
| | strength | | | | | |
| | (MPa) | | | | | |
| | Adhesion | −86 | −85 | −54 | −10 | −25 |
| | strength | | | | | |
| | variation | | | | | |
| | after | | | | | |
| | water- | | | | | |
| | resistant | | | | | |
| | aging | | | | | |
| | (%) | | | | | |

Referring to Tables 3 and 4, it can be confirmed that the organopolysiloxane compositions according to at least one embodiment have excellent water resistance as well as excellent shear bond strength and elongation.

1. An organopolysiloxane composition, comprising:
an organopolysiloxane polymer containing two or more silicon-bound hydroxyl groups or silicon-bound hydrolysable groups;
light calcium carbonate having a BET specific surface area of 15 to 35 m²/g;
heavy calcium carbonate having a BET specific surface area of 0.5 to 5 m²/g;
a curing-accelerating catalyst; and
a silane-based curing agent,
wherein a mixing weight ratio of the light calcium carbonate and the heavy calcium carbonate is 1:0.04 to 1:0.25, and the silane-based curing agent is a compound represented by Formula 4 below.
Gₓ-Si—R₄₋ₓ [Formula 4]
where G is selected from the group consisting of an alkoxy group, an acetoxy group, an oxime group and a hydroxyl group, R is selected from the group consisting of an C₁ to C₁₀ alkenyl group, a C₁ to C₁₀ alkynyl group and a C₆ to C₁₀ aryl group, and x is 2, 3 or 4.

2. The organopolysiloxane composition according to claim 1, wherein the light calcium carbonate has an average particle size of 0.02 to 0.1 μm, and is included at 40 to 70 wt % with respect to the total weight of the organopolysiloxane composition.

3. The organopolysiloxane composition according to claim 1, wherein the heavy calcium carbonate has an average particle size of 4 to 5 μm, and is included at 1 to 15 wt % with respect to the total weight of the organopolysiloxane composition.

4. The organopolysiloxane composition according to claim 1, further comprising a silane-containing compound including a mixed compound of an epoxyalkylalkoxysilane compound, an amino-substituted alkoxysilane compound and an alkylalkoxysilane compound.

5. The organopolysiloxane composition according to claim 4, wherein a mixing ratio of the epoxyalkylalkoxysilane compound, the amino-substituted alkoxysilane compound, and the alkylalkoxysilane compound is 1:0.05 to 0.4:0.1 to 0.5.

6. The organopolysiloxane composition according to claim 1, further comprising a glycol-based compound.

7. The organopolysiloxane composition according to claim 1, wherein the organopolysiloxane polymer has a viscosity of 1,000 to 100,000 cP at 25° C., and the composition further comprises an organopolysiloxane having a viscosity of 90 to 110 cSt at 25° C. as a silicone-based additive.
